(19) United States
(12) Patent Application Publication
(10) Pub. No.: US 2009/0144327 A1
(43) Pub. Date: Jun. 4, 2009

(54) METHODS, SYSTEMS, AND COMPUTER PROGRAM PRODUCTS FOR EXTRACTING DATA FROM A VISUAL IMAGE

(75) Inventor: Dale Malik, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 11/947,159

(22) Filed: Nov. 29, 2007

(51) Int. Cl. G06F 17/00

(52) U.S. Cl. 707/104.1; 707/E17.009

(57) ABSTRACT

Capturing a visual image, or a sequence of visual images, that includes an advertisement for a product, a service, or an event. The captured visual image is scanned by an optical character recognition application to detect key words. The key words are provided to an input/output (I/O) device to enable one or more of the key words to be confirmed, deleted, or edited. The key words include a key word identifying an electronic destination accessible over a network and corresponding to a source for the advertisement. At least one key word that has been confirmed or edited by the I/O device is transmitted over the network to the electronic destination corresponding to the source. Digitized data is received from the source, the digitized data comprising at least one of digitized event data, digitized product data, or digitized service data. The received digitized data are stored in an advertisement database.

### FIELD OF INVENTION

Exemplary embodiments relate generally to processing and storing electronic images and, more specifically, to methods, computer program products, and systems for extracting data from a visual image.

### BACKGROUND OF THE INVENTION

From time to time, an individual may encounter a visual advertisement such as a billboard, flyer, newspaper advertisement, or magazine advertisement. The advertisement may include several informational details about a product, a service, or an upcoming event. In the case of an event, the advertisement may include the name of the event, the venue hosting the event, the date and time of the event, a telephone number or email address for a promoter of the event, a Uniform Resource Locator (LRL) for a website that contains more information about the event, or any of various combinations thereof. Since the advertisement is non-interactive, the burden of remembering all of the informational details associated with the event, product or service is placed upon the individual viewing the advertisement. In order to accurately remember these details, the individual may take action such as writing the details on a scrap of paper, talking a photograph of the advertisement, or recording a voice mail message that describes the details. However, if one observes an advertisement while driving, cycling, or engaged in other demanding activities, it may not be possible to take written notes, snap a photograph, or record a voice mail message pertaining to the advertisement. Moreover, even if an individual creates a written note that includes all details, the note may become lost or misplaced. Likewise, as the date of an event approaches, or as the need for a product or service arises, an individual may need to sort through numerous digital photographs in order to locate a photograph of the advertisement. A voice mail message may also be difficult to locate, and is also subject to inadvetent erasure. In view of the foregoing, what is needed is an improved technique for extracting data from a visual image.

### SUMMARY OF THE INVENTION

Exemplary embodiments relate to methods for extracting data from a visual image. The methods include capturing a visual image, or a sequence of visual images, that include an advertisement for at least one of a product, a service, or an event. The captured visual image is scanned by an optical character recognition application to detect at least one key word. The at least one key word is provided to an input/output (I/O) device so as to enable one or more key words of the at least one key word to be confirmed, deleted, or edited. The at least one key word includes a key word identifying an electronic destination accessible over a network and corresponding to a source for the advertisement. At least one key word that has been confirmed or edited by the I/O device is electronically transmitted over the network to the electronic destination corresponding to the source. Digitized data is received from the source, the digitized data comprising at least one of digitized event data, digitized product data, or digitized service data. The received digitized data are stored in an advertisement database.

Another set of exemplary embodiments includes computer program products for extracting data from a visual image. The computer program products include a storage medium readable by a processing circuit and storing instructions for execution by the processing circuit for facilitating a method. The method includes capturing a visual image, or a sequence of visual images, that include an advertisement for at least one of a product, a service, or an event. The captured visual image is scanned by an optical character recognition application to detect at least one key word. The at least one key word is provided to an input/output (I/O) device so as to enable one or more key words of the at least one key word to be confirmed, deleted, or edited. The at least one key word includes a key word identifying an electronic destination accessible over a network and corresponding to a source for the advertisement. At least one key word that has been confirmed or edited by the I/O device is electronically transmitted over the network to the electronic destination corresponding to the source. Digitized data is received from the source, the digitized data comprising at least one of digitized event data, digitized product data, or digitized service data. The received digitized data are stored in an advertisement database.

Another set of exemplary embodiments includes a system for extracting data from a visual image. The system includes an image capture mechanism for capturing a visual image, or a sequence of visual images, that include an advertisement for at least one of a product, a service, or an event. The image capture mechanism is operatively coupled to an optical character recognition mechanism. The captured visual image is scaned by the optical character recognition mechanism to detect at least one key word. The optical character recognition mechanism is operatively coupled to an input/output (I/O) device. The optical character recognition mechanism provides the at least one key word to the I/O device so as to enable one or more key words of the at least one key word to be confirmed, deleted, or edited. The at least one key word includes a key word identifying an electronic destination accessible over a network and corresponding to a source for the advertisement. The I/O device is operatively coupled to a processing mechanism, and the processing mechanism is operatively coupled to a network. After the at least one key word is confirmed, deleted, or edited, the processing mechanism electronically transmits the at least one key word over the network to the electronic destination corresponding to the source. The processing mechanism receives digitized data from the source, the digitized data comprising at least one of digitized event data, digitized product data, or digitized service data. The processing mechanism is operatively coupled to an advertisement database. The processing mechanism stores the received digitized data in the advertisement database.

Other methods, computer program products, and systems according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF THE DRAWINGS

Referring now to the drawings wherein like elements are numbered alike in the several FIGURES:

FIG. 1 is a diagrammatic representation of an illustrative visual image that includes an advertisement for an event.

FIG. 2 is a simplified block diagram of an exemplary system for extracting data from a visual image.

FIG. 3 is a flowchart of an exemplary procedure for extracting data from a visual image.

The detailed description explains the exemplary embodiments, together with advantages and features, by way of example with reference to the drawings.

### DETAILED DESCRIPTION OF THE INVENTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

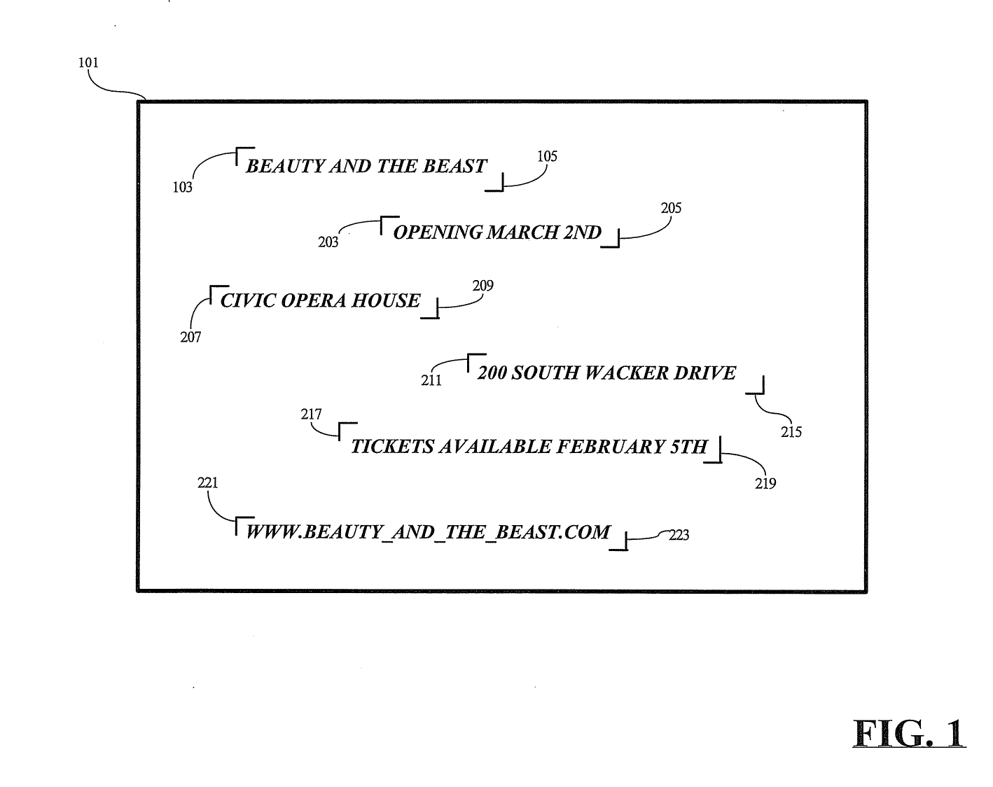

FIG. 1 is a diagrammatic representation of an illustrative visual image in the form of a visual advertisement 101 for an event. In this example, the visual advertisement 101 may represent a billboard, flyer, newspaper advertisement, or magazine advertisement. The visual advertisement 101 includes several informational details about an event. If the visual advertisement 101 were to pertain to a product or a service instead of an event, then visual advertisement may contain several informational details about the product or service. In the case of an event, the advertisement may include the name of an event. For example, the name of the event may be a play entitled “Beauty and the Beast”. To facilitate optical character recognition, the name may be placed in proximity to one or more optional visual markers such as a first visual marker 103 and a second visual marker 105.

The first visual marker 103 and the second visual marker 105 are used to facilitate identification of one or more keywords by an optical reader. More specifically, optical recognition of a keyword can be enhanced by placing a geometric shape or pattern before the keyword and after the keyword. The start of the keyword could be identified, for example, by the placement of a solid triangle, three small horizontal bars, an arrow, or another symbol directly in front of the keyword in a smaller font than the keyword, with another symbol showing where the keyword ends. The symbol showing where the keyword ends could, but need not, be implemented by inverting the symbol used to indicate the start or beginning of the keyword, or reversing the direction of the symbol used to indicate the start or beginning of the keyword (i.e., reversing the direction of an arrow), or using the same symbol in the same orientation to indicate the start and the end of the keyword, or using the same symbol in different orientations to indicate the start and the end of the keyword or using different symbols to indicate the start and the end of the keyword.

According to exemplary embodiments, the visual advertisement 101 also includes a name for the venue hosting the event which, in this case, is the historic Civic Opera House in Chicago. The optional visual markers 207, 209 are placed in proximity to the venue name. The opening date of the event, in this case March 2^{nd}, may be included and the optional visual markers 203, 205 are placed in proximity to this opening date. The address for the venue may also be given, as 200 South Wacker Drive. Illustratively, if this address were to be displayed on a billboard in the greater Chicagoland area, it would not be necessary to place the name of the city or state on the advertisement as viewers would deduce the city and state from the context of the billboard. On the other hand, a similar advertisement in a nationally circulated magazine may, but need not, include the name of the city and state. In the present example, the address is placed in proximity to the optional visual markers 211, 215.

The visual advertisement 101 may indicate when tickets associated with the event will be available, such as on February 5^{th} as illustrated in FIG. 1. According to exemplary embodiments, this ticket availability information is placed in proximity to the optional visual markers 217, 219. An electronic destination for a source of the advertisement may also be provided on the visual advertisement in the form of a Uniform Resource Locator (URL) for a website associated with the event. Digitized information about the event may be accessed and downloaded from this website. According to exemplary embodiments, the URL is placed in proximity to the optional visual markers 221, 223. Optionally, the visual advertisement 101 may include a logo or other identifying indicia which serves to inform viewers that a digitized version of the advertisement is available from the electronic destination provided in the advertisement, and that the digitized version of the advertisement may, but need not, contain information in addition to that provided in the visual advertisement 101.

In some situations, a particular electronic destination may be provided on a number of different visual advertisements pertaining to different events, products or services. Similarly, a particular electronic destination may be provided on a number of substantially identical visual advertisements. Accordingly, in each of the foregoing situations, the visual advertisement 101 may include an optional numeric, alphanumeric, or alphabetic code that enables the source of the advertisement to identify the specific visual advertisement for which a digitized version of the advertisement is being requested.

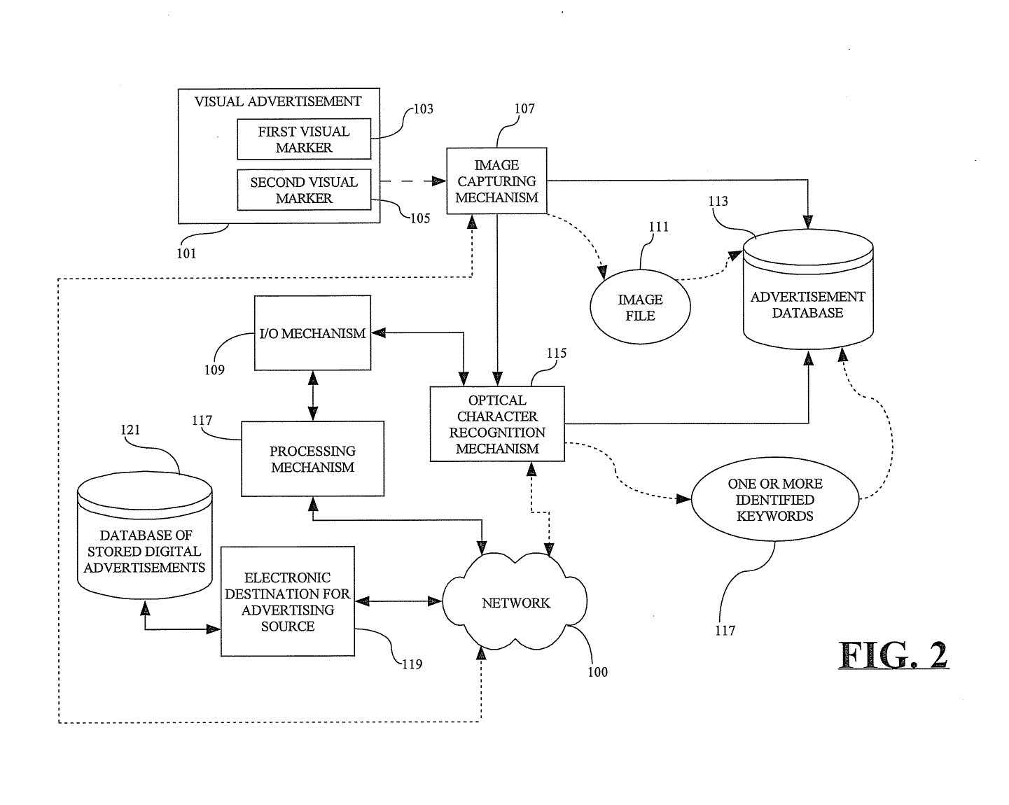

FIG. 2 is a simplified block diagram of an exemplary system for extracting data from an image comprising the visual advertisement 101 (FIGS. 1 and 2). The system of FIG. 2 includes an image capturing mechanism 107 for capturing a visual image, or a sequence of visual images, that includes an advertisement for at least one of a product, a service, or an event. For example, the image capturing mechanism 107 may be implemented using a camera built into a cellphone, a standalone digital camera, a webcam, or a camera connected to a laptop computer, personal computer, or personal digital assistant. The image could, but need not, be captured and stored in the form of a .JPG, .TIFF, .BMP, or .PDF file. Illustratively, image capturing mechanism may comprise a cellular telephone with a soft key or a dedicated key programmed for “event capture”, whereupon activation of the soft key or dedicated key initiates image capture and, optionally, an optical character recognition application.

According to exemplary embodiments, the image capturing mechanism 107 is operatively coupled to an optical character recognition mechanism 115. The optical character recognition mechanism 115 may include an optical character recognition application or software program running on a processing mechanism such as a microprocessor or computing device. The optical character recognition mechanism 115 may be implemented by the same physical device that implements the image capturing mechanism 107, or by a different physical device from the image capturing mechanism 107, or by a remote server accessed over a network 100.

A non-exhaustive list of examples for the network 100 includes wired or optical networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), or any combination thereof. The network 100 may include any combination of additional communication devices (not shown) such as gateways, routers, switches, and the like. Alternatively or additionally, the network 100 may be implemented using a wireless network. A non-exhaustive list of examples for a wireless network includes any network capable of implementing communication using Direct Sequence—Code Division Multiple Access (DS-CDMA), Global System for Mobile Communications (GSM), North American Digital Cellular (NADC), Time Division Multiple Access (TDMA), Extended-TDMA (E-TDMA), W-CDMA, GPRS, GSM, Enhanced Data for GSM Evolution (EDGE), 3G and 4 G communication, wireless local area networks such as 802.11, Bluetooth™, Zigbee™, ultra wideband (UWB), or various combinations thereof.

In accordance with exemplary embodiments, the captured visual image is scanned by the optical character recognition mechanism 115 to detect at least one key word. The optical character recognition mechanism 115 is operatively coupled to an input/output (I/O) mechanism 109. The I/O mechanism 109 represents any device that accepts user input and provides a humanly discernible output. Examples of I/O devices for the I/O mechanism 109 include a keyboard or keypad associated with an electronic display device as, for example, may be provided by a cellular telephone, wireless telephone, personal digital assistant, laptop computer, personal computer, or microprocessor-based device. The physical device used to implement the optical character recognition mechanism 115 or the image capturing mechanism 107, or both, may, but need not, be used to implement the I/O mechanism 109.

The optical character recognition mechanism 115 may provide the at least one key word to the I/O mechanism 109 so as to enable one or more key words of the at least one key word to be confirmed, deleted, or edited. For example, a user could delete extraneous information from the captured visual information, such as a portion of an unwanted billboard or newspaper ad that is immediately adjacent to an advertisement of interest. In order to facilitate identification of key words at the optical character recognition mechanism 115, one or more optional visual markers may be employed in proximity to key words appearing in the advertisement 101, including the first visual marker 103 (FIGS. 1 and 2) and the second visual marker 105, as described previously. According to exemplary embodiments, the at least one key word identified by the optical character recognition mechanism 115 includes a key word identifying an electronic destination for an advertising source 119.

The electronic destination for advertising source 119 comprises a destination that is accessible over the network 100, such as an Internet address in the form of a URL. As indicated above, the network 100 may represent the Internet, an intranet, a wireless telephone network, the public switched telephone network, or various combinations thereof. The electronic destination for advertising source 119 is operatively coupled to a database of stored digital advertisements 121 which includes digitized information corresponding to each of one or more visual advertisements such as the visual advertisement 101.

The I/O device 109 is operatively coupled to a processing mechanism 117 capable of initiating digital communications over the network 100. The processing mechanism 117 may, but need not, be implemented using a cellular telephone, wireless telephone, personal digital assistant, laptop computer, personal computer, or microprocessor-based device. The same physical device used to implement the processing mechanism 117 may, but need not, be used to implement any of the optical character recognition mechanism 115, the I/O mechanism 109, or the image capturing mechanism 107. The processing mechanism 117 may, but need not, encompass additional communication circuitry such as a radio frequency transceiver of a wireless device, a modem, an Ethernet card, a wireless local area network (WLAN) card, or the like.

After the at least one key word is confirmed, deleted, or edited, the processing mechanism 117 electronically transmits at least one key word that has been confirmed or edited by the I/O device 109 over the network 100 to the electronic destination for advertising source 119, in accordance with exemplary embodiments. The processing mechanism 117 may receive digitized data from the electronic destination for advertising source 119. The digitized data may comprise at least one of digitized event data, digitized product data, or digitized service data and may be retrieved from the database of stored digital advertisements 121. The processing mechanism 117 is operatively coupled to an advertisement database 113. According to exemplary embodiments, the processing mechanism 117 stores the received digitized data in the advertisement database 113. Optionally, the advertisement database 113 stores image data captured from the visual advertisement 101 as an image file 111 and associates the stored image data with one or more identified key words 145.

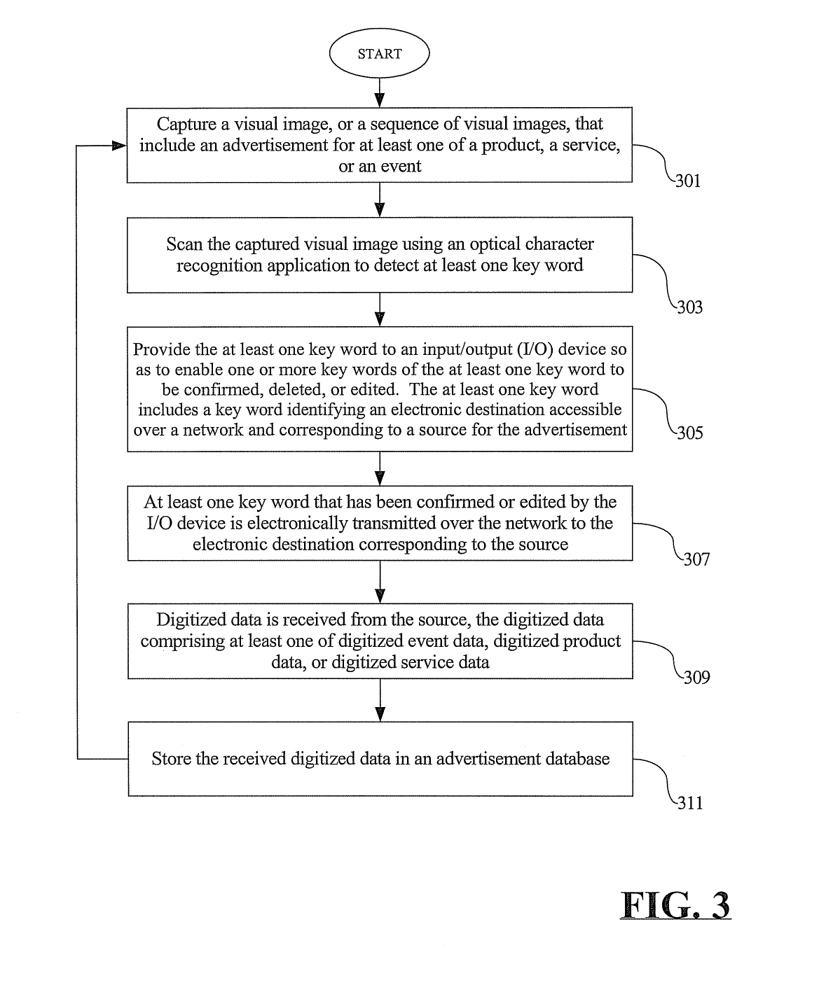

FIG. 3 is a flowchart of an exemplary procedure for extracting data from a visual image. The procedure commences at block 301 where a visual image, or a sequence of visual images, is captured. This step may be performed, for example, by the image capturing mechanism 107 (FIG. 2). The visual image may include the visual advertisement 101 (FIGS. 1 and 2), which may pertain to at least one of a product, a service, or an event. Next, at block 303 (FIG. 3), the captured visual image is scanned by an optical character recognition application to detect at least one key word. The optical character recognition application may be a software program executed by the optical character recognition mechanism 115 (FIG. 2). According to exemplary embodiments, the at least one key word includes a key word identifying an electronic destination accessible over a network and corresponding to a source for the advertisement. Additional key words may identify a location for an event, product, or service, a name for the event, product, or service, or other types of information relevant to the event, product, or service.

At block 305 (FIG. 3), the at least one key word is provided to an input/output (I/O) device, such as the I/O mechanism 109 (FIG. 2) so as to enable one or more key words of the at least one key word to be confirmed, deleted, or edited. Next, at block 307 (FIG. 3), at least one key word that has been confirmed or edited by the I/O device is electronically transmitted over the network 100 to an electronic destination corresponding to the source of the advertisement. This electronic destination is shown in FIG. 2 as the electronic destination for advertising source 119. At block 309 (FIG. 3), digitized data is received from electronic destination for advertising source 119 (FIG. 2). The digitized data may comprise at least one of digitized event data, digitized product data, or digitized service data. The received digitized data are stored in an advertisement database, such as the advertisement database 113 (FIG. 3, block 311). Optionally, the stored digitized data may be utilized to provide one or more inputs to an event manager software application. The event manager software application is any application that accepts a user input specifying one or more of an event, a meeting, a reminder, a schedule, or a personal calendar. One example of an event manager software application is Microsoft Outlook™.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for extracting data from a visual image, the method including:
capturing a visual image, or a sequence of visual images, that includes an advertisement for at least one of a product, a service, or an event;
scanning the captured visual image or the captured sequence of visual images by an optical character recognition application to detect at least one key word;
providing the at least one key word to an input/output (I/O) device so as to enable one or more key words of the at least one key word to be confirmed, deleted, or edited, wherein the at least one key word includes a key word identifying an electronic destination accessible over a network and corresponding to a source for the advertisement;
electronically transmitting at least one key word that has been confirmed or edited by the I/O device over the network to the electronic destination corresponding to the source; and
receiving digitized data from the source, the digitized data comprising at least one of digitized event data, digitized product data, or digitized service data.

2. The method of claim 1 further including storing the received digitized data in an advertisement database.

3. The method of claim 2 further including retrieving the stored digitized data from the advertisement database and applying the retrieved digitized data to an event manager software application.

4. The method of claim 3 wherein the scanning is performed on a remote server accessed over the network.

5. The method of claim 1 further including initiating the capturing by activating a soft key or a dedicated key on a cellular telephone.

6. The method of claim 5 wherein, upon activation of the soft key or dedicated key, the cellular telephone initiates the capturing and the scanning.

7. The method of claim 2 further including retrieving the stored digitized data from the advertisement database for use as an event reminder, or to procure a product or a service.

8. A computer program product for extracting data from a visual image, the computer program product including a storage medium readable by a processing circuit and storing instructions for execution by the processing circuit for facilitating a method comprising:
capturing a visual image, or a sequence of visual images, that includes an advertisement for at least one of a product, a service, or an event;
scanning the captured visual image or the captured sequence of visual images by an optical character recognition application to detect at least one key word;
providing the at least one key word to an input/output (I/O) device so as to enable one or more key words of the at least one key word to be confirmed, deleted, or edited, wherein the at least one key word includes a key word identifying an electronic destination accessible over a network and corresponding to a source for the advertisement;
electronically transmitting at least one key word that has been confirmed or edited by the I/O device over the network to the electronic destination corresponding to the source; and
receiving digitized data from the source, the digitized data comprising at least one of digitized event data, digitized product data, or digitized service data.

9. The computer program product of claim 8 further including instructions for storing the received digitized data in an advertisement database.

10. The computer program product of claim 9 further including instructions for retrieving the stored digitized data from the advertisement database and applying the retrieved digitized data to an event manager software application.

11. The computer program product of claim 8 wherein the scanning is performed on a remote server accessed over the network.

12. The computer program product of claim 8 further including instructions for initiating the capturing by activating a soft key or a dedicated key on a cellular telephone.

13. The computer program product of claim 12 wherein, upon activation of the soft key or dedicated key, the cellular telephone initiates the capturing and the scanning.

14. The computer program product of claim 9 further including retrieving the stored digitized data from the advertisement database for use as an event reminder, or to procure a product or a service.

15. A system for extracting data from a visual image, the system comprising:
an image capture mechanism for capturing a visual image, or a sequence of visual images, that includes an advertisement for at least one of a product, a service, or an event;
an optical character recognition mechanism, operatively coupled to the image capture mechanism, for scanning the captured visual image or the captured sequence of visual images to detect at least one key word;
an I/O device, operatively coupled to the optical character recognition mechanism, wherein the optical character recognition mechanism provides the at least one key word to the I/O device so as to enable one or more key words of the at least one key word to be confirmed, deleted, or edited; and wherein the at least one key word includes a key word identifying an electronic destination accessible over a network and corresponding to a source for the advertisement; and
a processing mechanism operatively coupled to a network and to the I/O device, wherein, after the at least one key word is confirmed, deleted, or edited, the processing mechanism electronically transmits over the network at least one key word that has been confirmed or edited by the I/O device to the electronic destination corresponding to the source; the processing mechanism receiving digitized data from the source, the digitized data comprising at least one of digitized event data, digitized product data, or digitized service data.

16. The system of claim 15 further comprising an advertisement database, operatively coupled to the processing mechanism, for storing the received digitized data.

17. The system of claim 16 further comprising an event manager operatively coupled to the advertisement database, wherein the stored digitized data is retrieved from the advertisement database and applied to the event manager.

18. The system of claim 15 wherein the optical character recognition mechanism comprises a remote server accessed over the network.

19. The system of claim 15 wherein the image capture mechanism includes a cellular telephone equipped with a soft key which, upon activation, initiates the capturing of the visual image.

20. The system of claim 15 wherein the image capture mechanism includes a cellular telephone equipped with a dedicated key which, upon activation, initiates the capturing of the visual image.

21. The system of claim 19 wherein the cellular telephone further comprises an optical character recognition mechanism.

22. The system of claim 20 wherein the cellular telephone further comprises an optical character recognition mechanism.

23. The system of claim 16 wherein the I/O device further comprises a mechanism for retrieving and displaying the stored digitized data from the advertisement database for use as an event reminder, or to procure a product or a service.
